(19) United States
(12) Patent Application Publication
(10) Pub. No.: US 2026/0348191 A1
(43) Pub. Date: Nov. 5, 2026

(54) Swivel Lever for Actuating a Closure Apparatus of an Access Control Device and Swivel Lever System

(71) Applicant: DIRAK Dieter Ramsauer Konstruktionselemente GmbH, Ennepetal (DE)

(72) Inventors: Peter Höschler, Velbert (DE); Noah Fassbender, Sprockhövel (DE)

(21) Appl. No.: 19/123,798

(22) PCT Filed: Sep. 19, 2023
(86) PCT No.: PCT/EP2023/075739

§ 371 Date: Apr. 24, 2025

(30) Foreign Application Priority Data
Oct. 25, 2022 (DE) 10 2022 128 269.4

(51) Int. Cl. E05B 1/00; E05B 13/10; E05B 47/00; E05C 3/04

(52) U.S. Cl. CPC E05B 1/0092; E05B 13/106; E05B 47/0045; E05C 3/042

(57) ABSTRACT

A swivel lever for actuating a closure apparatus of an access control device with a base part for fastening the swivel lever and an actuating lever for actuating the closure apparatus is described and shown, wherein the actuating lever is pivotable relative to the base part between a latched position for latching the actuating lever on the base part and an actuating position and wherein at least one locking element for securing the actuating lever against unauthorised pivoting from the latched position into the actuating position is provided so as to be adjustable between a locking position positively blocking the pivoting of the actuating lever and a release position enabling the pivoting of the actuating lever. In order that the properties of the swivel lever can be improved with a high level of protection against soiling and damage from the outside, it is provided that the at least one locking element is adjustable by adjusting at least one adjusting magnet-from a base position into an unlocking position from the locking position into the release position, that the at least one adjusting magnet is adjustable from the base position into the unlocking position by way of a magnetic interaction with at least one key magnet of a key suitable for the swivel lever and that the at least one locking element and the at least one adjusting magnet are formed from different materials.

### CROSS-REFERENCE TO RELATED APPLICATIONS

This application is the United States National Phase of International Patent Application No. PCT/EP2023/075739 filed Sep. 19, 2023, and claims priority to German Patent Application No. 10 2022 128 269.4 filed Oct. 25, 2022, the disclosures of which are hereby incorporated by reference in their entireties.

### BACKGROUND OF THE INVENTION

### Field of the Invention

The invention relates to a swivel lever for actuating a closure apparatus, in particular a bolt closure means and/or rod closure means, an access control device, in particular a door and/or hatch, with a base part for fastening the swivel lever, in particular to the access control device, and an actuating lever for actuating the closure apparatus, wherein the actuating lever is pivotable relative to the base part between a latched position for latching the actuating lever on the base part and an actuating position for actuating the closure apparatus and/or when the closure apparatus is actuated and wherein at least one locking element for securing the actuating lever against unauthorised pivoting from the latched position into the actuating position is provided so as to be adjustable between a locking position positively blocking the pivoting of the actuating lever and a release position enabling the pivoting of the actuating lever. In addition, the invention relates to a swivel lever system with at least one such swivel lever and a key suitable for the swivel lever.

### Description of Related Art

Access control devices with which access points can be locked and released are known in various configurations, for example in the form of doors or hatches. In this case, access control devices, regardless of their configuration, often have at least one closure apparatus in order to be able to prevent the access control device from unintentionally moving from a position closing the access into a position releasing the access and/or from being adjusted accordingly by unauthorised persons.

Closure apparatuses are, for example, bolt closure means. Bolt closure means usually have at least one bolt which is adjustable between a position for positively blocking the opening of the access control device and a position for enabling the opening of the access control device. In this case, bolt closure means, in which the bolt can be pivoted and/or turned, are often also referred to as rotary bolt closure means. In addition to bolt closure means, so-called rod closure means are known, which typically have at least one rod element. In this case, the at least one rod element allows the access control device to be fixed at two or more points, for example on a frame, spaced apart from one another, for example located opposite one another. This can increase the security against the unauthorised opening of the access control device.

Irrespective of the configuration of the closure apparatus, swivel levers are often used to actuate the closure apparatus. Swivel levers typically comprise a base part, with which the swivel lever can be fastened to the access control device, and an actuating lever used to actuate the closure apparatus. In this case, the actuating lever is generally pivotable relative to the base part between a latched position, in which the actuating lever can be latched on the base part, and an actuating position, in which the closure apparatus can be actuated with the actuating lever. Swivel levers offer the advantage that a high torque can be introduced into the closure apparatus with little effort.

In order to secure the actuating lever against unauthorised pivoting, for example by unauthorised persons, from the latched position into the actuating position, swivel levers often have at least one locking element. In this case, the at least one locking element is typically adjustable between a locking position, in which the locking element positively blocks the pivoting of the actuating lever from the latched position into the actuating position, and a release position, in which the locking element enables the pivoting of the actuating lever from the latched position into the actuating position. A key suitable for the swivel lever is typically provided for adjusting the at least one locking element from the locking position into the release position.

Such a swivel lever and such a swivel lever system are known from DE 10 2020 108 484 A1. In this case, the at least one locking element is designed as a locking magnet and the key has at least one key magnet such that the locking magnet can be adjusted from the locking position into the release position by way of a magnetic interaction with the key magnet. This has the advantage that the at least one locking magnet does not have to be accessible from the outside when the actuating lever is closed in order to be able to be adjusted from the locking position into the release position. This means that the locking mechanism can be better protected against soiling and damage from the outside, for example due to vandalism. However, there is still a need for a swivel lever with improved properties.

### SUMMARY OF THE INVENTION

Therefore, the object underlying the present invention is to configure and further develop the swivel lever and the swivel lever system of the type mentioned at the outset and described in more detail above in such manner that the properties of the swivel lever can be improved with a high level of protection against soiling and damage from the outside.

This object is achieved in the case of a swivel lever as described herein in that the at least one locking element is adjustable from the locking position into the release position by adjusting at least one adjusting magnet from a base position into an unlocking position, in that the at least one adjusting magnet is adjustable from the base position into the unlocking position by way of a magnetic interaction with at least one key magnet of a key suitable for the swivel lever and in that the at least one locking element and the at least one adjusting magnet are formed from different materials.

The mentioned object is further achieved by a swivel lever system as described herein with at least one swivel lever and a key which is suitable for the swivel lever and comprises at least one key magnet for adjusting the at least one adjusting magnet of the swivel lever from the base position into the unlocking position.

According to the invention, the swivel lever thus has at least one adjusting magnet, which is adjustable from a base position into an unlocking position. In this case, the at least one locking element can be adjusted from the locking position into the release position by adjusting the at least one adjusting magnet from the base position into the unlocking position. The at least one adjusting magnet is in turn adjustable from the base position into the unlocking position by way of a magnetic interaction with at least one key magnet of a key suitable for the swivel lever. The magnetic interaction between the at least one adjusting magnet and the at least one key magnet can thus cause an adjustment of the adjusting magnet from the base position into the unlocking position, which in turn can cause an adjustment of the at least one locking element from the locking position into the release position. On the one hand, this enables a high degree of protection against soiling and damage from the outside, since neither the adjusting magnet nor the locking element need to be accessible from the outside in the latched position of the actuating lever in order to be able to adjust the locking element from the locking position into the release position. Rather, the at least one adjusting magnet and/or the at least one locking element can be inaccessible from the outside in the latched position of the actuating lever. On the other hand, it is made possible for the at least one locking element to be formed from a different material than the at least one adjusting magnet. In this way, the materials and thus the material properties of the locking element and the adjusting magnet can be adapted independently of each other to the respective purpose of use and thus ultimately improve the properties of the swivel lever. In this case, the at least one locking element can in particular be optimised with respect to its mechanical properties and the at least one adjusting magnet with respect to its magnetic properties.

In order not to impair the functionality of the at least one adjusting magnet, the base part, the actuating lever and/or a base body of the key can be formed from a non-ferromagnetic material. Aluminium and/or zinc are particularly suitable materials. The base part, the actuating lever and/or a base body of the key can be manufactured particularly economically by die-casting, generally regardless of the material.

The base part, which can be designed in one piece or multiple pieces, is in particular provided for fastening the swivel lever to the access control device. In principle, however, it is also conceivable to fasten the swivel lever by means of the base part to a component other than the access control device, for example to a frame supporting the access control device, such as a cabinet. Irrespective of this, the actuating lever can expediently be pivotably held on the base part.

The actuating lever can be provided so that the closure apparatus is actuated when the actuating lever is in the actuating position. The closure apparatus can then be actuated by pivoting the actuating lever from the latched position into the actuating position. However, it is preferred if the actuating lever is pivotable between the latched position and the actuating position about a latching axis and is pivotable in the actuating position for actuating the closure apparatus about an actuating axis inclined, in particular at least substantially perpendicular, to the latching axis.

Irrespective of the design of the actuating position, it may be advisable if the actuating lever in the latched position is at least partially, in particular at least substantially, received in a lever receptacle of the base part. This may not only contribute to a flat configuration of the swivel lever, but also to good protection of the locking mechanism against external influences. In this case, the lever receptacle can expediently be designed as a hollow. In principle, independently of receiving the actuating lever in a lever receptacle, it may be advisable if pivoting of the actuating lever about the actuating axis is positively blocked in the latched position of the actuating lever.

The magnetic interaction between the at least one adjusting magnet and the key magnet, in particular assigned to the adjusting magnet, can for example be a magnetically attractive interaction. Functionally, however, it is preferred if it is a magnetically repelling interaction. Irrespective of this, the adjusting magnet can expediently be adjusted into the unlocking position in a position of use of the key by way of the magnetic interaction between the at least one adjusting magnet and the key magnet, in particular assigned to the adjusting magnet.

The swivel lever and/or the swivel lever system may comprise the closure apparatus and/or the access control device as required. However, this is not absolutely necessary.

For the sake of clarity and to avoid unnecessary repetition, the swivel lever and the swivel lever system are described together below, without distinguishing in detail between the swivel lever and the swivel lever system in each case. However, it will be apparent to a person skilled in the art, given the context, which feature is particularly preferred with respect to the swivel lever and/or the swivel lever system.

In a first particularly preferred configuration of the swivel lever, the swivel lever has at least two locking elements. In this way, the security against the swivel lever being forcibly adjusted out of the latched position can be increased. For the same reason, it can be all the more advantageous if the swivel lever has at least three, if necessary at least four, preferably at least six, particularly preferably at least eight, locking elements. Regardless of the specific number, the locking elements can then expediently be adjustable in each case between a locking position positively blocking the pivoting of the actuating lever and a release position enabling the pivoting of the actuating lever. With respect to a high level of security against unauthorised unlocking of the actuating lever, it may then be further advisable for the swivel lever to have a number of adjusting magnets which correspond to the number of locking elements and which are assigned to one of the locking elements in each case. The locking elements can then expediently be adjustable in each case by adjusting the assigned adjusting magnet from a base position into an unlocking position from the locking position into the release position, wherein the adjusting magnets can in each case be adjustable from the base position into the unlocking position by way of a magnetic interaction with a key magnet of the key. In this case, it can also be provided that the pole orientations of at least two of the adjusting magnets differ in relation to the respective unlocking direction. In this way, a type of coding can be implemented, which can contribute to increased security against unauthorised unlocking. This applies all the more if the pole orientations of at least two adjacently arranged adjusting magnets differ in relation to the respective unlocking direction. Irrespective of this, the unlocking direction is basically understood in particular as the direction in which the adjusting magnet is adjustable from the base position into the unlocking position.

Irrespective of the number of locking elements and adjusting magnets, it can contribute to a flat configuration of the swivel lever if the swivel lever comprises at least one lateral locking element for positively blocking the pivoting of the actuating lever on a longitudinal side of the actuating lever. Then the at least one lateral locking element in the locking position can thus positively block the pivoting of the actuating lever from the latched position into the actuating position on a longitudinal side of the actuating lever.

Irrespective of this, it may be advisable with respect to a high level of security against forcible adjustment of the actuating lever for the swivel lever to comprise at least two, preferably at least four, in particular at least six, particularly preferably at least eight, lateral locking elements. Then, for the same reason, it can be particularly advisable if the lateral locking elements for positively blocking the pivoting of the actuating lever are designed on opposite longitudinal sides of the actuating lever. Irrespective of this, the at least one lateral locking element can be designed simply and expediently in the form of a pin.

Alternatively or in addition to a lateral locking element, it may be advisable with respect to a high level of security against unauthorised adjustment of the actuating lever from the latched position if the swivel lever has at least one rear locking element for positively blocking the pivoting of the actuating lever on a rear side of the actuating lever assigned to the base part. The rear locking element can then, in the locking position, positively block the pivoting of the actuating lever from the latched position into the actuating position on the rear side of the actuating lever assigned to the base part.

With respect to simple and cost-effective manufacture as well as flexible use of the swivel lever, it may be advisable if the at least one adjusting magnet is formed from a permanently magnetic material. Permanent magnets can, for example, in contrast to electromagnets, permanently generate an, in particular at least substantially constant, magnetic field without external energy supply. Independently of this, neodymium-iron-boron (Nd2Fe14B), which enables a high magnetic field strength at moderate costs, in particular may be advisable as a permanently magnetic material. Alternatively or in addition to a permanently magnetic design of the adjusting magnet, the at least one locking element can preferably be formed from a non-permanently magnetic material. Materials that are not permanently magnetic may, for example, be advisable for the locking element with respect to their mechanical and/or manufacturing properties.

From a functional point of view, it may also be advisable for the at least one locking element to be formed from a ferromagnetic material. The locking element can then be adjustable by way of a magnetic interaction with the adjusting magnet, in particular assigned to the locking element. Irrespective of this, a ferromagnetic material may be advisable in particular in the case of the at least one lateral locking element. As an alternative to a ferromagnetic design, the locking element can be formed from a non-ferromagnetic material. This can be particularly advantageous in the case of a complex geometry of the locking element from a manufacturing point of view, which can be particularly advantageous in the case of the rear locking element.

With respect to a secure locking of the actuating lever against forcible adjustment from the latched position, it may be advantageous if the material of the at least one locking element has a higher shear strength than the material of the adjusting magnet, in particular assigned to the locking element. In this way, the security against breakage of the locking element, which is typically subjected to high shear forces when the actuating lever is forcibly adjusted from the latched position, can be increased. For the same reason, it may, for example, be advisable for the shear strength of the material of the at least one locking element to be at least 1.2 times, if necessary at least 1.5 times, preferably at least twice, in particular at least three times, particularly preferably at least four times, as high as the shear strength of the material of the adjusting magnet. Irrespective of a corresponding ratio, the shear strength of the material of the at least one locking element can for example be at least 50 N/mm², preferably at least 100 N/mm², in particular at least 150 N/mm².

Irrespective of the shear strength, the locking element can be manufactured by die-casting. Die-casting also enables cost-effective production of complex geometries, which can be particularly useful for the rear locking element. Alternatively or in addition to manufacture by die-casting, the at least one locking element can be formed from a metallic material. With respect to their properties, metallic materials are particularly advisable for the locking element. This applies all the more to steel materials, in particular due to their mechanical properties. A steel material can be particularly useful for the at least one lateral locking element. Irrespective of this, ferritic steel materials can be particularly preferred functionally as they are typically highly magnetic. Alternatively or additionally, a galvanised steel material and/or stainless steel may be advisable to prevent corrosion. Alternatively or in addition to a steel material, the locking element can be formed from an aluminium material and/or zinc material. Aluminium and zinc materials enable the simple and cost-effective manufacture even of complex geometries, for example by die-casting, which can be particularly useful for the rear locking element.

With respect to a space-saving design, it may be advisable for the at least one locking element and the adjusting magnet, in particular assigned to the locking element, to be adjustable independently of each other. This is particularly advisable in the case of the at least one lateral locking element. Irrespective of this, it may be functionally expedient if the at least one locking element is adjustable from the release position into the locking position and/or back independently of the adjusting magnet. For the same reason, it may alternatively or additionally be advisable for the at least one adjusting magnet to be adjustable independently of the locking element from the base position into the unlocking position and/or back.

Alternatively or in addition to an adjustment independently of one another, it may be advisable with respect to a simple design configuration for the locking element and the adjusting magnet, in particular assigned to the locking element, to be adjustable exclusively together. This is particularly advisable for the rear locking element.

Irrespective of whether the locking element and the adjusting magnet are adjustable independently of one another or together, the adjustment of the at least one locking element from the locking position into the release position by the adjusting magnet, in particular assigned to the locking element, can be carried out constructively simply and reliably positively. Then, in particular, the at least one adjusting magnet can adjust the at least one locking element positively from the locking position into the release position when adjusting from the base position into the unlocking position. Alternatively or additionally, it may also be advisable for the aforementioned reasons for the at least one adjusting magnet to abut the locking element during adjustment from the base position into the unlocking position.

It can also contribute to a space-saving design if the at least one locking element is displaceable between the locking position and the release position. This is particularly advisable in the case of the at least one lateral locking element. Alternatively or in addition to a displaceability of the locking element, the at least one adjusting magnet can be displaceable between the base position and the unlocking position for the same reason. This is in particular advisable if the adjusting magnet is assigned to a lateral locking element. Irrespective of this, the displacement of the locking element and/or the adjusting magnet can be carried out particularly easily and reliably along the longitudinal axis of the locking element. Alternatively or in addition to a displaceability along the longitudinal axis of the locking element, it can be functionally and constructively simple if the at least one locking element and the adjusting magnet, in particular assigned to the locking element, are displaceable along the same axis. A flat design of the swivel lever can alternatively or additionally be made possible if the displacement of the locking element and/or the adjusting magnet can take place at least substantially parallel to a contact plane of the swivel lever in which the swivel lever can abut the access control device.

Alternatively or in addition to a displaceability, the locking element can be pivotable between the locking position and the release position about a pivot axis. This is advisable for the rear locking element with respect to a simple design. Alternatively or additionally, it may be advisable for the same reason for the adjusting magnet to be pivotable about a pivot axis between the base position and the unlocking position, which is advisable in particular in the case of the adjusting magnet assigned to the rear locking element. Irrespective of this, it can be further advisable for design reasons for the at least one pivot axis to be arranged at least substantially parallel to a contact plane of the swivel lever in which the swivel lever can abut the access control device. Alternatively or additionally, it may also be advisable for the same reason for the pivot axis of the locking element and/or of the adjusting magnet to be arranged at least substantially parallel to a latching axis about which the actuating lever is pivotable between the latched position and the actuating position.

The at least one locking element can be easily and expediently held so as to be adjustable between the locking position and the release position on the base part or on the actuating lever. Then the at least one, in particular lateral, locking element can for example be held in a simple manner directly on the base part or actuating lever. Alternatively or additionally, the locking element, in particular the rear locking element, can be held on the base part via an adapter element for design reasons. Irrespective of the locking element, the at least one adjusting magnet can also be held easily and expediently so as to be adjustable between the base position and the unlocking position on the actuating lever or on the base part. In this case, it may be advisable with respect to permanently reliable operation for the at least one locking element and/or the at least one adjusting magnet to be held in a captive manner on the base part or actuating lever. This can be done simply and reliably in a positive-locking manner. Alternatively or additionally, it may be advisable with respect to reliable adjustment and at the same time space-saving configuration for the at least one locking element to be held so as to be adjustable in a guide of the base part or the actuating lever, wherein a guide of the base part can be particularly useful in terms of design. Irrespective of this, a holder in a guide is particularly advisable in the case of the at least one lateral locking element. Alternatively or additionally, for the same reason, the at least one adjusting magnet can be held so as to be adjustable in a guide of the actuating lever or of the base part, wherein a guide of the actuating lever is particularly preferred in terms of design. A holder in a guide is particularly useful if the adjusting magnet is assigned to a lateral locking element.

Regardless of how the locking element and the adjusting magnet are held on the base part or the actuating lever, it can contribute to a space-saving configuration if the at least one locking element is held on the base part and the at least one adjusting magnet, in particular assigned to the locking element, is held on the actuating lever or vice versa. This is particularly advisable in the case of the at least one lateral locking element. Irrespective of this, a design is particularly preferred when the locking element is held on the base part and the adjusting magnet on the actuating lever.

Alternatively or additionally, with respect to a simple design, it may be advisable for the locking element and the adjusting magnet, in particular assigned to the locking element, to both be held on the base part or both on the actuating lever. This can in particular be simple in terms of design for the rear locking element. Irrespective of this, a holder on the base part can be particularly useful with respect to a simple design. Alternatively or additionally, the adjusting magnet can be held simply and expediently via the locking element on the base part or actuating lever.

In order to enable a flat configuration of the swivel lever on the side of the access control device facing the actuating lever, the locking element, in particular regardless of its position, can be arranged at least partially on the side of a contact plane which faces away from the actuating lever and in which the swivel lever can abut the access control device. This can be particularly useful for the rear locking element. Irrespective of this, a particularly flat configuration can be made possible if the locking element is arranged not only partially, but at least substantially on the side of the contact plane facing away from the actuating lever.

If the locking element is arranged at least partially on the side of the contact plane facing away from the actuating lever, it can be functionally and constructively simple if the actuating lever has at least one locking section that engages the contact plane in the latched position of the actuating lever. Then the at least one locking section in the latched position of the actuating lever with the, in particular rear, locking element in the locking position can form the at least one positive-locking connection blocking the pivoting of the actuating lever. With respect to a high level of security against forcible adjustment of the actuating lever, it may be advisable for the actuating lever to have at least two corresponding locking sections. Alternatively or additionally, the at least one locking section of the actuating lever can simply and at the same time expediently have the shape of a hook.

The locking element can, constructively simply and expediently, have an at least substantially L-shaped base body. This is particularly advisable for the rear locking element. Irrespective of this, it can additionally contribute to a simple and expedient design if the locking element is pivotable about a pivot axis extending through a free end of an L-limb of the base body between the locking position and the release position. Alternatively or additionally, the locking element can have at least one locking section protruding laterally from the base body for forming the at least one positive-locking connection blocking the pivoting of the actuating lever. This can further simplify the design. Then, namely, the at least one locking section in the locking position of the locking element with the actuating lever in the latched position can form the at least one positive-locking connection blocking the pivoting of the actuating lever. Irrespective of this, it may be advisable with respect to a high level of security against forcible adjustment of the actuating lever for the locking element to have two laterally protruding locking sections. Then, for the same reason, it may be particularly preferred if the locking sections protrude from the base body in opposite directions. Alternatively or additionally, it may be advisable in terms of design for the at least one locking section to be connected to the base body in a connection region of the two L-limbs of the L-shaped base body.

Irrespective of an L-shaped base body, it can be simple and expedient if the adjusting magnet is at least partially received in a magnet receptacle of the locking element, in particular assigned to the adjusting magnet. This can be particularly useful for the adjusting magnet assigned to the rear locking element. Irrespective of this, the adjusting magnet can be particularly reliably received not only partially, but at least substantially in the magnet receptacle. For the same reason, it can also alternatively or additionally be advisable for the magnet receptacle to be designed to correspond to the adjusting magnet. Irrespective of a corresponding configuration, the magnet receptacle can also be arranged on a free end of an L-limb of the L-shaped base body of the locking element for design reasons.

In order to provide a reliable positive-locking connection in a simple manner, the locking element can engage positively behind at least one undercut of the actuating lever and/or the actuating levers can engage positively behind at least one undercut of the locking element when the actuating lever is in the latched position and the locking element is in the locking position. This is particularly advisable for the rear locking element. Irrespective of this, it may be advisable with respect to a particularly high level of security against forcible pivoting of the actuating lever for the locking element to engage behind two undercuts of the actuating lever and/or the actuating levers to engage behind two undercuts of the locking element. Alternatively or additionally, it may be expedient if the at least one locking section of the locking element and/or the actuating lever engages behind the at least one undercut and/or forms the at least one undercut.

Alternatively or in addition to engaging behind an undercut, a reliable positive-locking connection can be implemented in a particularly space-saving manner when, in the latched position of the actuating lever, the at least one locking element engages positively in a locking receptacle of the actuating lever or of the base part in the locking position. This may be useful in particular in the case of the at least one lateral locking element. Irrespective of this, it may be constructively simple for the case that the at least one adjusting magnet, in particular assigned to the locking element, is held in a guide, if the at least one locking receptacle is formed by the at least one guide of the adjusting magnet. Alternatively or additionally, it may also be constructively preferred if the actuating lever has the at least one locking receptacle. Irrespective of this, it may be expedient for the at least one locking element to be arranged in the release position outside the locking receptacle, preferably independently of the position of the actuating lever.

In order to prevent the locking element from unintentionally entering the release position, at least one securing element can be provided for holding the at least one locking element in the locking position. Then the at least one locking element can be held in the locking position by the at least one securing element when the actuating lever is in the latched position. Irrespective of this, unintended retention of the locking element in the release position can be avoided if the at least one securing element is additionally designed to automatically adjust the at least one locking element from the release position into the locking position. Then the at least one locking element can thus be automatically adjustable from the release position into the locking position by the at least one securing element. Irrespective of this and for the aforementioned reasons it may be expedient in the case of a plurality of locking elements for at least one securing element to be assigned to the locking elements in each case. Alternatively or additionally, the holding of the locking element in the locking position and/or the automatic adjustment of the locking element from the release position into the locking position can be caused simply and expediently by a securing force. Then, for the same reason, it may also be advisable if the securing force is a magnetic force, in particular a magnetically attractive force.

If the securing force is a magnetic force, the at least one securing element can expediently be designed as an, in particular permanently magnetic, securing magnet. Then the at least one securing magnet can be formed by the at least one adjusting magnet to save space. This is in particular advisable if the securing magnet is assigned to a lateral locking element.

Alternatively, the at least one securing magnet and the at least one adjusting magnet may be designed as separate components. This may be advisable for design reasons, in particular if the securing magnet is assigned to the rear locking element. Irrespective of this, it can be constructively useful, in particular in the case of a separate design of the securing magnet, if the at least one securing magnet is held on the locking element or fixedly on the base part. For the sake of simplicity, the at least one securing magnet can be held in a magnet receptacle, in particular formed in a corresponding manner. Alternatively or additionally, at least two securing magnets can be assigned to the locking element for increasing the securing force. This can be particularly useful in the case of the rear locking element. Alternatively or additionally, one of the two securing magnets can then expediently be held on the locking element and the other securing magnet fixedly on the base part.

In order to avoid the adjusting magnet unintentionally entering the unlocking position, the swivel lever can have at least one holding element for holding the at least one adjusting magnet, in particular assigned to the lateral locking element, in the base position. Then the at least one adjusting magnet can thus be held in the base position by the at least one holding element if the adjusting magnet is not adjusted into the unlocking position by means of the key. In order to avoid unintended retention of the adjusting magnet in the unlocking position, irrespective of this, the at least one holding element can be further designed to adjust the at least one adjusting magnet automatically from the unlocking position into the base position. Then the at least one adjusting magnet can be automatically adjustable from the unlocking position into the base position by the at least one holding element. Irrespective of this, a holding element is useful in particular in the case of an adjusting magnet, which is adjustable independently of the locking element in particular assigned to the adjusting magnet. Alternatively or additionally, the at least one holding element can expediently be formed separately from the at least one securing element. Irrespective of this, it may be advisable for the sake of simplicity in the case of a plurality of adjusting magnets for one holding element to be assigned to a plurality of adjusting magnets.

The holding of the adjusting magnet in the base position and/or the automatic adjustment of the adjusting magnet from the unlocking position into the base position can be easily and expediently effected by a holding force. Then, for the same reason, it can also be advisable for the holding force to be a magnetic holding force, in particular a magnetically attractive holding force. In particular if the holding force is magnetic, it may be preferred if the at least one holding element is formed from a ferromagnetic material. Alternatively or additionally, it may be functionally preferred if the at least one holding element is formed from a non-permanently magnetic material. Irrespective of this, the at least one holding element can be designed simply and expediently as a sheet metal, in particular sheet metal strips.

In order to simplify the pivoting of the actuating lever from the actuating position into the latched position, the at least one locking element can be automatically adjustable from the locking position into the release position when the actuating lever is pivoted from the actuating position into the latched position. Thus, pivoting the actuating lever from the actuating position into the latched position can cause the at least one locking element to be adjusted from the locking position into the release position. Complex separate adjustment of the at least one locking element from the locking position into the release position can then be omitted. Irrespective of this, the automatic adjustment of the at least one locking element can be carried out simply and reliably in a positive-locking manner.

The automatic adjustment of the locking element from the locking position into the release position can be made constructively simple if the actuating lever has at least one sliding surface. Then the at least one sliding surface of the actuating lever can slide on the at least one locking element when the actuating lever is pivoted from the actuating position into the latched position and thereby automatically adjust the locking element from the locking position into the release position. Alternatively or additionally, the at least one locking element can have a sliding surface for the same reason. The sliding surface of the at least one locking element can then slide on the actuating lever when the actuating lever is pivoted from the actuating position into the latched position and thereby automatically adjust the locking element from the locking position into the release position. With respect to a particularly reliable adjustment of the locking element, it may be advisable for the at least one sliding surface of the actuating lever and the sliding surface of the at least one locking element to be designed to slide on one another. Irrespective of this, the at least one sliding surface can be constructively simply formed by a chamfer. Alternatively or additionally, it may be expedient if the at least one sliding surface of the actuating lever is arranged in the position in sliding contact with the at least one locking element and/or the sliding surface of the at least one locking element is arranged obliquely, for example at an angle of at least 30° and/or at most 60°, in particular about 45°, to the release direction of the locking element in the locking position. The release direction can basically be understood in particular as the direction in which the locking element is adjustable from the locking position into the release position.

In order to facilitate the pivoting of the actuating lever out of the latched position, the actuating lever can be pivoted into the latched position against a restoring force. The restoring force can then assist the pivoting of the actuating lever out of the latched position. Irrespective of this, the restoring force can be provided in a simple manner by a spring means, for example in the form of an elbow spring.

In order to contribute to a high level of security against unauthorised unlocking of the actuating lever in addition to simple pivoting of the actuating lever, a force can act, in the latched position of the actuating lever, on the at least one locking element in the locking position by way of the restoring force and counteracts an adjustment of the locking element in the release position. In this case, it can be constructively simple if the force counteracting the adjustment into the release position is caused by a frictional connection. Irrespective of this, it can be particularly simple by design if the frictional connection acts between the at least one locking element and the actuating lever and/or between the at least one locking element and the base part.

It can contribute to a simple configuration of the locking mechanism if the swivel lever has a key receptacle for receiving the key at least in sections, in particular at least predominantly. Then, the, for example rod-shaped, key can be received in the key receptacle, preferably inserted into the key receptacle, in a position of use at least in sections, in particular at least predominantly. Irrespective of this, it can additionally contribute to a simple locking mechanism if the, preferably elongated, key receptacle extends along the longitudinal axis of the actuating lever and/or along the longitudinal axis of the base part. Alternatively or additionally, it can contribute to a compact configuration of the swivel lever if the key receptacle is formed by the actuating lever and/or the base part, wherein it can be particularly useful for the same reason for the key receptacle to be at least substantially formed by the actuating lever. Irrespective of this, a particularly flat configuration of the swivel lever can be achieved if the actuating lever and the base part form the key receptacle together. Alternatively or additionally, for design reasons, it may be advisable for at least two of the adjusting magnets in particular assigned to one of the lateral locking elements and/or at least two holding elements to be arranged on opposite sides, in particular longitudinal sides, of the key receptacle.

In a first particularly preferred configuration of the swivel lever system, the key receptacle of the swivel lever and the keys have cross-sections corresponding to one another. This facilitates precise arrangement of the key in the key receptacle when unlocking the actuating lever. For the same reason, it can then also be advisable for the corresponding cross-sections to have corresponding form elements for aligning the key in the key receptacle. This ensures that the key can only be inserted into the key receptacle in a predefined alignment, which simplifies handling. For the sake of simplicity, the form elements can be designed as indentations.

Irrespective of the corresponding cross-sections of the key receptacle and the key, the key can be designed as a master key. The key can then expediently have at least one master key magnet, which is assigned to an empty position of the swivel lever. In this case, in particular no adjusting magnet of the swivel lever is assigned to the master key magnet.

Instead, the at least one master key magnet can be used to unlock at least one further swivel lever, which can differ with respect to the arrangement of the at least one adjusting magnet from the swivel lever of the swivel lever system. In this way, differently coded swivel levers can be unlocked with one key. For the same reason, it is particularly advisable for the at least one master key magnet to be designed to adjust at least one adjusting magnet of the at least one further swivel lever from the base position into the unlocking position. Irrespective of this, the at least one further swivel lever can expediently be part of the swivel lever system. However, this is not absolutely necessary.

### BRIEF DESCRIPTION OF THE DRAWINGS

The terms Fig., Figs., Figure, and Figures are used interchangeably in the specification to refer to the corresponding figures in the drawings.

The invention is explained in greater detail below by means of a drawing representing only one exemplary embodiment. In the drawing

FIG. 1 schematically shows a swivel lever system according to the invention comprising a swivel lever according to the invention with an actuating lever in an actuating position and a key in a position of non-use in a perspective view,

FIG. 2 schematically shows the swivel lever from FIG. 1 with the actuating lever in a latched position in a perspective view,

FIGS. 3A-B schematically show the swivel lever from FIG. 1 with the actuating lever in the latched position without the key in various sectional views,

FIGS. 4A-C schematically show cutouts of the swivel lever from FIG. 1 with the actuating lever in the latched position without the key in various sectional views and a perspective view from below at an angle,

FIGS. 5A-B schematically show the swivel lever system from FIG. 1 with the actuating lever in the latched position and the key in a position of use in different sectional views,

FIGS. 6A-B schematically show the swivel lever system from FIG. 1 with the actuating lever in the latched position and the key in the position of use in different sectional views,

FIGS. 7A-C schematically show cutouts of the swivel lever from FIG. 1 with the actuating lever in positions pivoted out of a lever receptacle without the key in various sectional views and

FIG. 8 schematically shows the swivel lever system from FIG. 1 with the actuating lever in the actuating position in a side view.

In the figures, magnetic north poles of magnets are marked with “N” and magnetic south poles of magnets with “S”.

### DESCRIPTION OF THE INVENTION

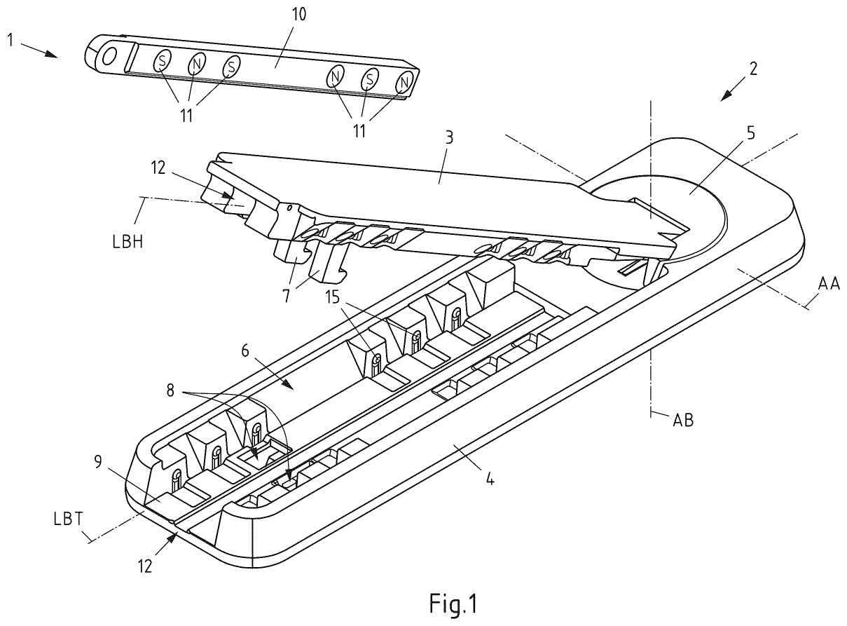

FIG. 1 shows a swivel lever system 1 comprising a swivel lever 2 with an actuating lever 3 in an actuating position in a perspective view. In addition to the actuating lever 3, the swivel lever 2 has a base part 4. The actuating lever 3 here is held pivotably on the base part 4 via a rotary plate 5 in such manner that the swivel lever 2 is pivotable relative to the base part 4 about an actuating axis AB and a latching axis AA at least substantially perpendicular to the actuating axis AB. The base part 4 has a hollow-shaped lever receptacle 6 in which the actuating lever 3 can be received.

The actuating lever 3 has two, in this case hook-shaped, locking sections 7 on its rear side assigned to the base part 4, which protrude from the base body of the actuating lever 3 in the direction of the base part 4. In this case, the locking sections 7 are each provided for reaching through a recess 8 in the bottom 9 of the base part 4.

In addition to the swivel lever 2, the swivel lever system 1 has a key 10 suitable for the swivel lever 2. The present rod-shaped key 10 has a plurality of permanently magnetic key magnets 11, which differ with respect to their pole orientation. Here, the key 10 is represented in a position of non-use. To receive the key 10 in a position of use, the swivel lever 2 has a key receptacle 12, which, in the swivel lever 2 represented and preferred in this respect, is formed predominantly by the actuating lever 3 and partially by the base part 4. The key receptacle 12 extends here along the longitudinal axis LBH of the actuating lever 3 and the longitudinal axis LBT of the base part 4.

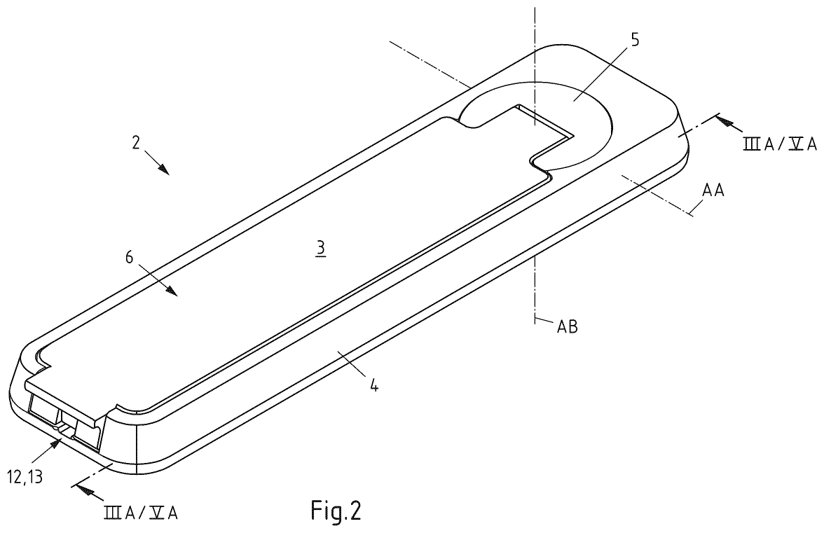

In the actuating position represented in FIG. 1, the actuating lever 3 is pivoted out of the lever receptacle 6 such that the actuating lever 3 can be pivoted about the actuating axis AB relative to the base part 4. In order to latch the actuating lever 3 on the base part 4, the actuating lever 3 can be pivoted about the latching axis AA on the base part 4 into the latched position represented in FIG. 2.

FIG. 2 shows the swivel lever 2 with the actuating lever 3 in the latched position in a perspective view. The actuating lever 3 is at least substantially received in the lever receptacle 6 of the base part 4 such that the pivoting of the actuating lever 3 about the actuating axis AB is positively blocked. The key receptacle 12 formed by the actuating lever 3 and the base part 4 has, at its longitudinal end assigned to the free end of the actuating lever 3, a key opening 13 through which the key 10, not represented, can be inserted into the key receptacle 12.

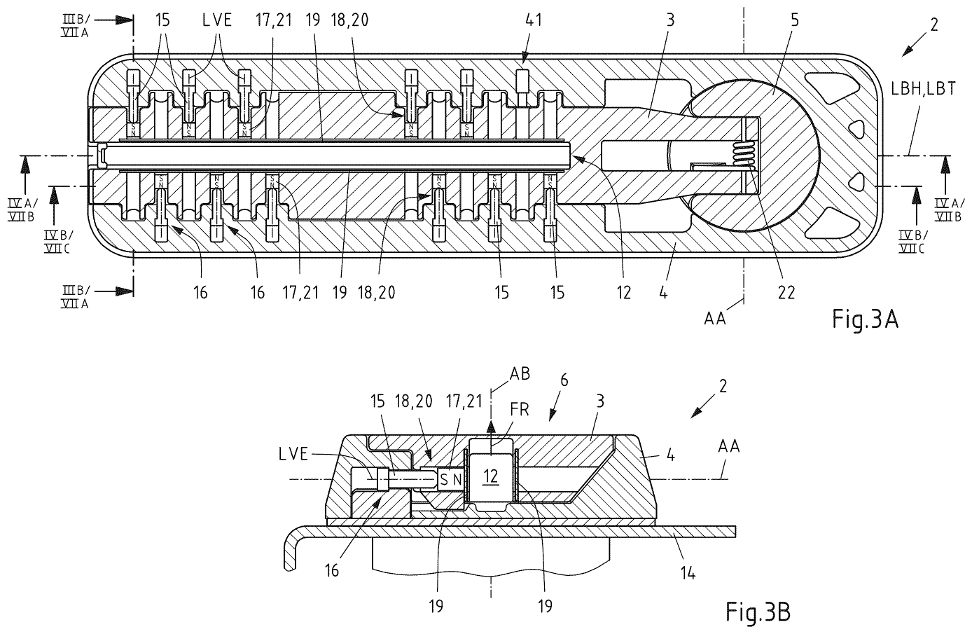

FIGS. 3A-B show the swivel lever 2 with the actuating lever 3 in the latched position without the key 10 in two sectional views along the section plane IIIA-IIIA represented in FIG. 2 and the section plane IIIB-IIIB represented in FIG. 3A. The swivel lever 2 is fastened by means of the base part 4 to an access control device 14 not represented in FIG. 3A, for example in the form of a sheet metal door and/or sheet metal hatch.

In the exemplary embodiment represented and preferred in this respect, the swivel lever 2 has eleven lateral locking elements 15 formed as steel pins here, which are arranged along the longitudinal axis LBT of the base part 4 distributed on opposite sides of the longitudinal axis LBT. The lateral locking elements 15 are held on the base part 4 in guides 16 of the base part 4 in a captive manner. In this case, the lateral locking elements 15 are each displaceable along their longitudinal axis LVE in the associated guide 16.

An adjusting magnet 17 formed from a permanently magnetic material is assigned to the lateral locking elements 15 in each case. The adjusting magnets 17 are held on the actuating lever 3 in guides 18 of the actuating lever 3 in a captive manner, wherein the adjusting magnets 17 are each displaceable along the longitudinal axis LVE of the associated lateral locking element 15 in the guides 18. In this case, the lateral locking elements 15 are also displaced outwards by displacing the adjusting magnets 17 outwards in a positive-locking manner.

The actuating lever 3 has a holding element 19 on the opposite longitudinal sides of the key receptacle 12 in each case. In this case, the holding elements 19 are formed as ferromagnetic sheet metal strips, which extend here along the longitudinal axis LBH of the actuating lever 3 and along the adjusting magnets 17.

The lateral locking elements 15 are each arranged in a locking position. In the locking position, the locking elements 15 held on the base part 4 engage positively in locking receptacles 20 of the actuating lever 3, wherein the locking receptacles 20 are formed here by the guides 18 for the adjusting magnets 17. In this way, the pivoting of the actuating lever 3 about the latching axis AA out of the represented latched position and out of the lever receptacle 6 is positively blocked by the lateral locking elements 15.

The adjusting magnets 17 assigned to the lateral locking elements 15 are each arranged in a base position. In the base position, the adjusting magnets 17 hold the lateral locking elements 15 in the represented locking position by way of the magnetically attractive interactions between the adjusting magnets 17 and the locking elements 15. This prevents the lateral locking elements 15 from unintentionally entering a position in which said locking elements 15 would enable the pivoting of the actuating lever 3 out of the latched position and out of the lever receptacle 6. In the exemplary embodiment represented and preferred in this respect, the adjusting magnets 17 therefore also function as securing elements 21 for the lateral locking elements 15. The adjusting magnets 17 are in turn held in the represented base position by way of the magnetically attractive interactions with the ferromagnetic sheet metal strips 19.

In the exemplary embodiment represented and preferred in this respect, a spring means 22 acts between the actuating lever 3 and the rotary plate 5 and is designed here as an elbow spring. Through the spring means 22, a restoring force FR acts on the actuating lever 3 and supports the pivoting of the actuating lever 3 about the latching axis AA out of the lever receptacle 6. In this case, the restoring force FR between the lateral locking elements 15 on the one hand and the actuating lever 3 as well as the base part 4 on the other respectively causes a frictional connection, which counteracts an adjustment of the corresponding locking element 15 out of the associated locking receptacle 20.

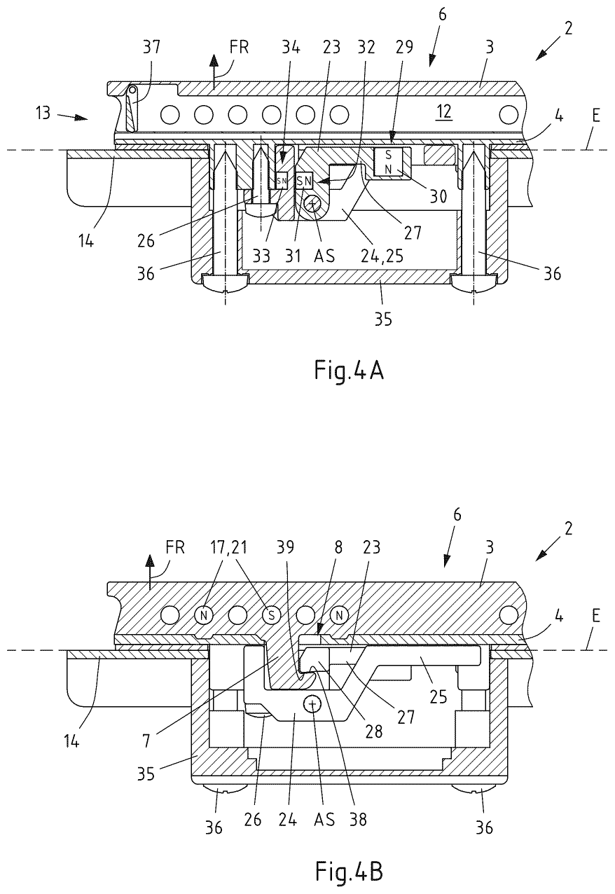

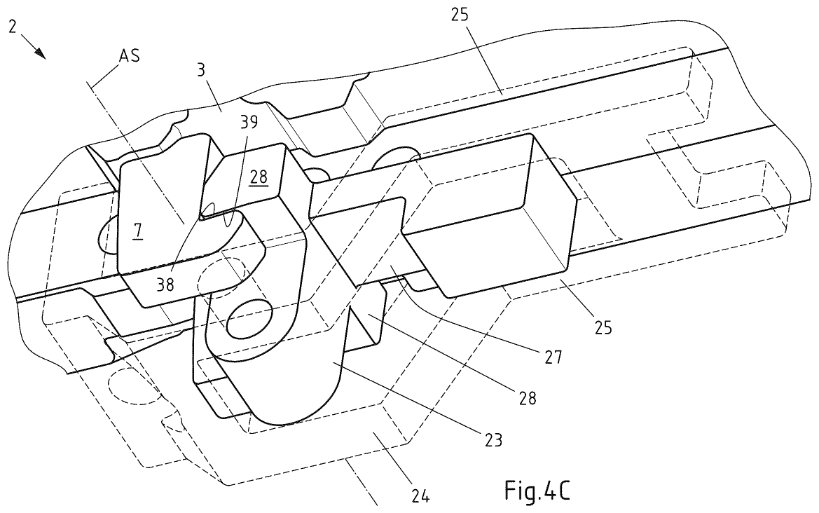

FIGS. 4A-C show cutouts of the swivel lever 2 with the actuating lever 3 in the latched position without the key 10 in two sectional views along the section planes IVA-IVA and IVB-IVB represented in FIG. 3A and an isometric view from the bottom at an angle. For better clarity, only the actuating lever 3 as well as a rear locking element 23 and an adapter element 24 of the swivel lever 2 are represented in FIG. 4C. The rear locking element 23, which is manufactured here by die-casting from an aluminium and/or zinc material, is arranged at least substantially on the side of a contact plane E which faces away from the actuating lever 3 and in which the swivel lever 2 abuts the access control device 14. In this case, the rear locking element 23 is held on the adapter element 24 so as to be pivotable about a pivot axis AS at least substantially parallel to the contact plane E. In the present case, the rear locking element 23 is held between two longitudinal struts 25 of the adapter element 24, which are connected to each other in the region of their longitudinal ends. The adapter element 24 is in turn fastened to the base part 4 by means of a screw connection 26.

The rear locking element 23 has a substantially L-shaped base body 27 and two locking sections 28, which protrude laterally from the L-shaped base body 27. In this case, the pivot axis AS of the rear locking element 23 extends through a free end of one of the two L-limbs of the L-shaped base body 27. At the free end of the other of the two L-limbs of the L-shaped base body 27 a magnet receptacle 29 is provided, in which an adjusting magnet 30 assigned to the rear locking element 23 is received and formed from a permanently magnetic material. In addition to the adjusting magnet 30, a similarly permanently magnetic securing magnet 31 is held on the rear locking element 23 in a magnet receptacle 32 of the locking element 23. In this case, the securing magnet 31 held on the rear locking element 23 acts together with a permanently magnetic securing magnet 33 which is held fixedly here on the base part 4 via the adapter element 24 and which is received in a magnet receptacle 34 of the adapter element 24.

The rear locking element 23 and the adapter element 24 are shielded from the environment by a cover cap 35. In this case, the cover cap 35 is held by a screw connection 36 on the base part 4, wherein the access control device 14 is clamped between the base part 4 and the cover cap 35. In this way, the swivel lever 2 is fastened to the access control device 14 in the exemplary embodiment represented and preferred in this respect.

In order to prevent the ingress of coarse dirt into the key receptacle 12 formed here by the base part 4 and the actuating lever 3, a protective flap 37 is provided in the region of the key opening 13 of the key receptacle 12. In this case, the protective flap 37 in the exemplary embodiment represented and preferred in this respect is held on the actuating lever 3 so as to be pivotable between a position at least substantially closing the key opening 13 and a position releasing the key opening 13.

The rear locking element 23 is arranged in a locking position. In the locking position, the locking sections 28 of the rear locking element 23 each engage behind an undercut 38 of the actuating lever 3. In this case, the undercuts 38 of the actuating lever 3 are each formed here by one of the two hook-shaped locking sections 7 of the actuating lever 3, which engage the recesses 8 of the base part 4 and the contact plane E. The hook-shaped locking sections 7 of the actuating lever 3 in turn each engage behind an undercut 39 of one of the locking sections 28 of the rear locking element 23. In this way, pivoting of the actuating lever 3 out of the represented latched position is positively blocked by the rear locking element 23.

Due to the magnetically attractive interaction between the securing magnet 31 held on the rear locking element 23 and the securing magnet 33 held on the adapter element 24, the locking element 23 is held in the represented locking position and thus also the adjusting magnet 30 held on the locking element 23 in the represented base position. This prevents the rear locking element 23 unintentionally entering a position in which it would enable the pivoting of the actuating lever 3. In this case, a frictional connection also acts through the restoring force FR of the spring means 22, not represented in FIGS. 4A-C, between the hook-shaped locking sections 7 of the actuating lever 3 and the locking sections 28 of the rear locking element 23 and counteracts a pivoting of the locking element 23 about the pivot axis AS.

To pivot the actuating lever 3 from the latched position represented in FIGS. 3A-B and 4A-C about the latching axis AA into an actuating position, the pin-shaped key 10, not represented here, can be inserted via the key opening 13 into the key receptacle 12 and thus adjusted into a position of use. In this case, the protective flap 37 is pivoted by contact with the key 10 in a positive-locking manner from the position, which is represented in FIG. 4A and which at least substantially closes the key opening 13, into a position which releases the key opening 13.

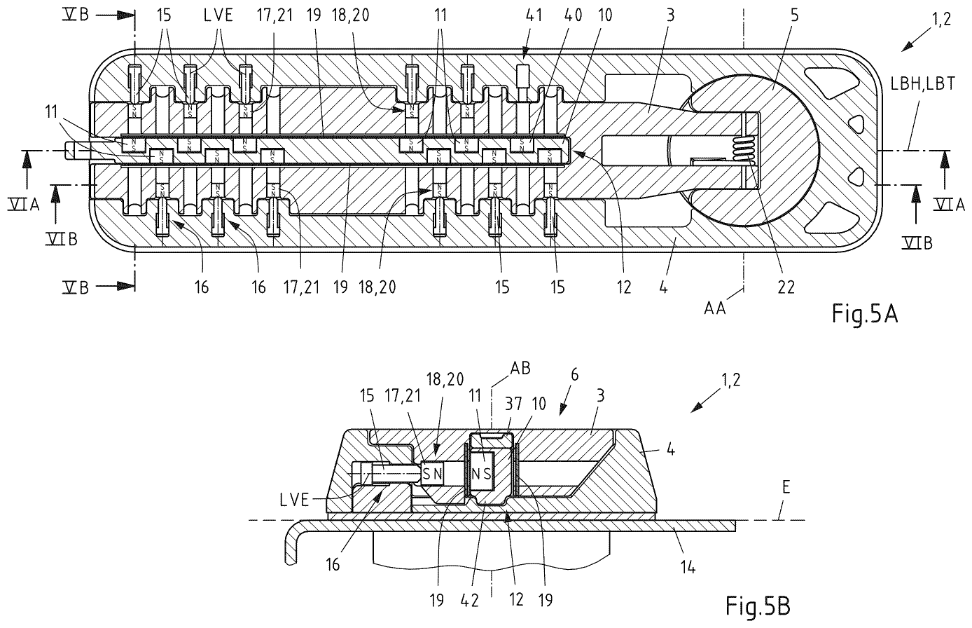

FIGS. 5A-B show the swivel lever system 1 with the actuating lever 3 in the latched position and the key 10 in the position of use in two sectional views along the section plane VA-VA represented in FIG. 2 and the section plane VB-VB represented in FIG. 5A. The key magnets 11 of the key 10 are each assigned to one of the lateral locking elements 15 of the swivel lever 2 and the associated adjusting magnet 17. In this case, the magnetically repelling interactions between the key magnets 11 and the adjusting magnets 17 are greater than the magnetically attractive interactions between the adjusting magnets 17 and the ferromagnetic holding elements 19, such that the adjusting magnets 17 are each displaced along the longitudinal axis LVE of the assigned lateral locking element 15 from the base position (FIGS. 3A-B) into an unlocking position.

By displacing the adjusting magnets 17 assigned to the lateral locking elements 15 from the base position (FIGS. 3A-B) into the unlocking position, the lateral locking elements 15 are each displaced along their longitudinal axis LVE from the locking position (FIGS. 3A-B) into a release position. In the released position, the lateral locking elements 15 are arranged outside the locking receptacles 20 of the actuating lever 3 such that the pivoting of the actuating lever 3 about the latching axis AA out of the lever receptacle 6 is enabled by the lateral locking elements 15.

The adjusting magnets 17 assigned to the lateral locking elements 15 differ with respect to their pole orientations. In the present case, the magnetic poles of adjacent adjusting magnets 17 are each aligned opposite to each other. However, this is not absolutely necessary. Rather, the magnetic poles of the adjusting magnets 17 can be aligned as desired and thus any coding can be realised.

When the key 10 is removed from the key receptacle 12, the adjusting magnets 17 assigned to the lateral locking elements 15 are automatically displaced from the represented unlocking position in the direction of the holding elements 19 into the base position by the magnetically attractive interactions with the ferromagnetic holding elements 19 (FIGS. 3A-B). The displacement of the adjusting magnets 17 in turn, due to the magnetically attractive interactions between the adjusting magnets 17 and the lateral locking elements 15, causes the locking elements 15 to be automatically displaced from the represented release position into the locking position (FIGS. 3A-B), in which the locking elements 15 engage in the locking receptacles 20 of the actuating lever 3.

In the present case, the key 10 is designed as a master key 10 and has, in addition to the key magnets 11, a master key magnet 40. The master key magnet 40 and the key magnets 11 assigned to the lateral locking elements 15 are designed in the same way in the exemplary embodiment represented and preferred in this respect. However, in contrast to the key magnets 11, the master key magnet 40 is not assigned to a locking element 15, 23 and thus also not to an adjusting magnet 17, 30 of the swivel lever 2. Instead, the master key magnet 40 is assigned to an empty space 41 of the swivel lever 2. In this case, a guide 16 for a locking element and a guide 18 for an adjusting magnet are provided at the empty space 41. However, this is not mandatory. For example, the swivel lever 2 could alternatively also be formed as a solid piece in the region of the empty space 41. By means of the master key magnet 40, at least one further swivel lever 2 can be unlocked, which has at the position of the empty space 41 a locking element assigned to the master key magnet 40 and an adjusting magnet assigned to the master key magnet 40.

In the exemplary embodiment represented and preferred in this respect, the cross-section of the key 10 is formed corresponding to the cross-section of the key receptacle 12. In this case, both the key 10 and the key receptacle 12 have a form element 42 in the form of an indentation in the cross-section. This ensures that the key 10 can only be inserted into the key receptacle 12 in the predefined alignment.

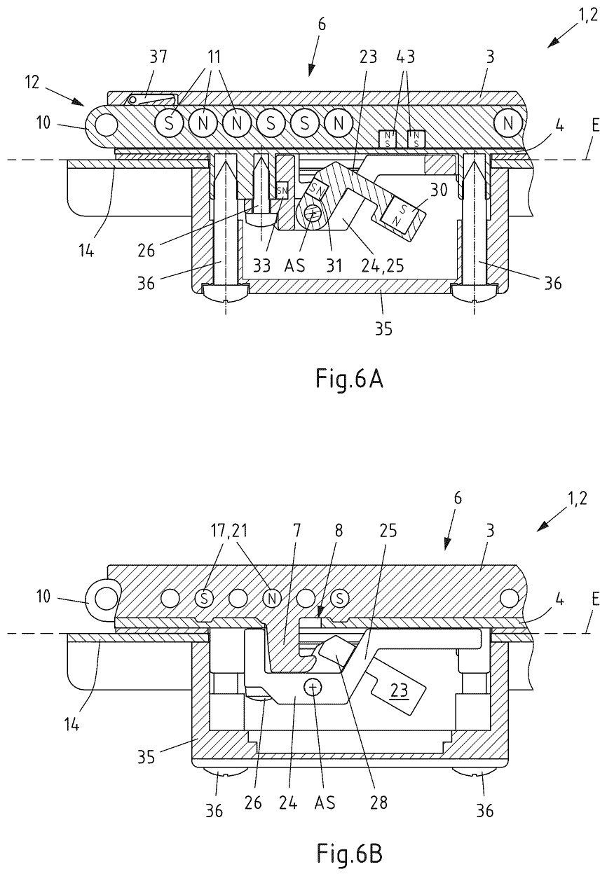

FIGS. 6A-B show cutouts of the swivel lever system 1 with the actuating lever 3 in the latched position and the key 10 in the position of use in two sectional views along the section planes VIA-VIA and VIB-VIB represented in FIG. 5A. In addition to the key magnets 11, which are assigned to the lateral locking elements 15 and the associated adjusting magnets 17, the key 10 here has two key magnets 43, which are assigned to the rear locking element 23 and the associated adjusting magnet 30. In this case, the magnetically repelling interactions between the key magnets 43 and the adjusting magnet 30 are greater than the magnetically attractive interactions between the two securing magnets 31, 33 assigned to the rear locking element 23, such that the adjusting magnet 30 is pivoted about the pivot axis AS from the base position (FIGS. 4A-C) into an unlocking position.

By pivoting the adjusting magnet 30 from the base position (FIGS. 4A-C) into the unlocking position, the rear locking element 23 is also pivoted about the pivot axis AS from the locking position (FIGS. 4A-C) into a release position. In the release position of the rear locking element 23, the mutual rear engagement between the locking element 23 and the hook-shaped locking sections 7 of the actuating lever 3 is cancelled such that the pivoting of the actuating lever 3 about the latching axis AA out of the lever receptacle 6 is enabled by the rear locking element 23. When the key 10 is removed from the key receptacle 12, the magnetically attractive interaction between the securing magnets 31, 33 automatically displaces the rear locking element 23 from the represented unlocking position about the pivot axis AS into the locking position (FIGS. 4A-C), in which the locking element 23 blocks the pivoting of the actuating lever 3.

In order to prevent the rear locking element 23 from entering a position in which the magnetic interaction between the two securing magnets 31, 33 is at least substantially cancelled, the locking element 23 abuts the longitudinal struts 25 of the adapter element 24 in the represented release position with its laterally protruding locking sections 28. Thus, further pivoting of the rear locking element 23 about the pivot axis AS away from the securing magnet 33 held on the adapter element 24 is positively blocked by the adapter element 24.

From the latched position represented in FIGS. 5A-B and 6A-B, the actuating lever 3 can be pivoted together with the key 10 inserted into the key receptacle 12 about the latching axis AA out of the lever receptacle 6 into an actuating position, for example the one represented in FIG. 1.

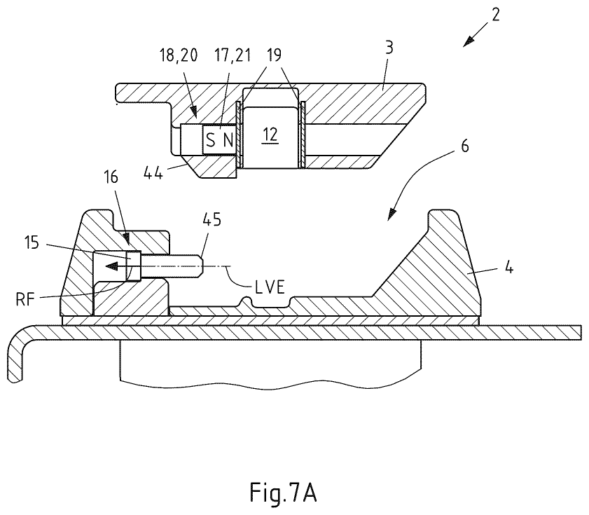

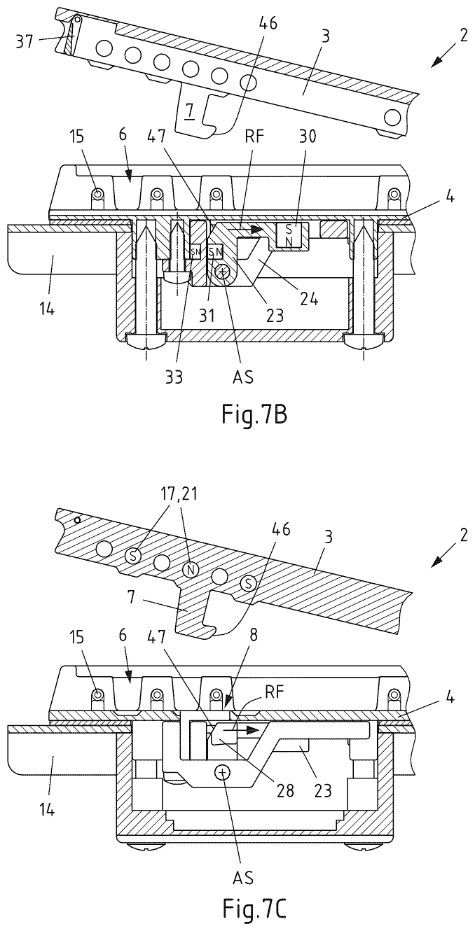

FIG. 7A shows a cutout of the swivel lever 2 in the region of one of the lateral locking elements 15 without the key 10 in a sectional view along the section plane VIIA-VIIA represented in FIG. 3A with the actuating lever 3 in a position at least partially pivoted out of the lever receptacle 6. The adjusting magnet 17 assigned to the lateral locking element 15 is arranged in the base position and held there by the magnetically attractive interaction with the associated holding element 19. The lateral locking element 15, which is freely displaceable in the associated guide 16 along its longitudinal axis LVE, is arranged in the locking position.

The actuating lever 3 has a sliding surface 44 assigned to the lateral locking element 15 in the form of a chamfer 44 below the guide 18 for the adjusting magnet 17. In the exemplary embodiment represented and preferred in this respect, the lateral locking element 15 also has a sliding surface 45 at its longitudinal end assigned to the actuating lever 3 in the form of a chamfer 45 running around the longitudinal axis LVE of the locking element 15. In this case, the sliding surfaces 44, 45 are arranged obliquely, here at an angle of about 45°, to a release direction RF of the locking element 15.

When the actuating lever 3 is pivoted in the direction of the lever receptacle 6, the sliding surface 44 of the actuating lever 3 and the sliding surface 45 of the lateral locking element 15 slide on each other. As a result, the lateral locking element 15 is displaced from the represented locking position in the release direction RF into the release position (FIG. 5B). This prevents the lateral locking element 15 from blocking the pivoting of the actuating lever 3 into the lever receptacle 6. As soon as the actuating lever 3 is then located in the latched position received in the lever receptacle 6 (FIG. 3B) and the locking receptacle 20 is arranged flush with the lateral locking element 15, the locking element 15 is automatically displaced from the release position (FIG. 5B) into the represented locking position by the magnetically attractive interaction with the adjusting magnet 17, which in this case acts as a securing element 21.

FIGS. 7B-C show cutouts of the swivel lever 2 without the key 10 in sectional views along the section planes VIIB-VIIB and VIIC-VIIC represented in FIG. 3A with the actuating lever 3 in a position at least partially pivoted out of the lever receptacle 6. The rear locking element 23 is arranged in the locking position and held there by the magnetically attractive interaction between the securing magnets 31, 33 assigned to the locking element 23.

In the exemplary embodiment represented and preferred in this respect, the hook-shaped locking sections 7 of the actuating lever 3 and the locking sections 28 of the rear locking element 23 each have a sliding surface 46, 47 in the form of a chamfer. In this case, the sliding surfaces 46, 47 are arranged obliquely, here at an angle of about 45°, to a release direction RF of the rear locking element 23.

When the actuating lever 3 is pivoted in the direction of the lever receptacle 6, the sliding surfaces 46 of the hook-shaped locking sections 7 of the actuating lever 3 slide on the sliding surfaces 47 of the locking sections 28 of the rear locking element 23. As a result, the rear locking element 23 is displaced against the magnetically attractive interaction between the securing magnets 31, 33 from the represented locking position in the release direction RF into the release position (FIGS. 6A-B) such that the hook-shaped locking sections 7 of the actuating lever 3 can pass the locking sections 28 of the rear locking element 23. This prevents the rear locking element 23 from blocking the pivoting of the actuating lever 3 into the lever receptacle 6. As soon as the actuating lever 3 is then located in the latched position received in the lever receptacle 6 (FIGS. 4A-B), the rear locking element 23 is automatically pivoted again from the release position (FIGS. 6A-B) into the represented locking position by way of the magnetically attractive interaction between the securing magnets 31, 33.

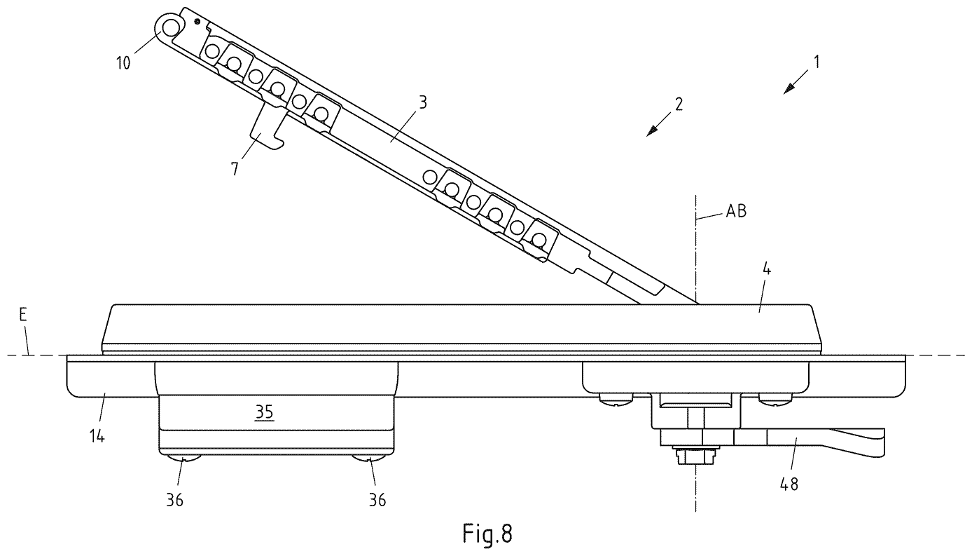

FIG. 8 shows the swivel lever system 1 with the actuating lever 3 in the actuating position in a side view. The actuating lever 3 of the swivel lever 2 is connected in a rotationally-fixed manner in relation to the actuating axis AB to a closure apparatus 48 which is formed here as a rotary bolt closure and which is arranged on the side of the contact plane E opposite the actuating lever 3. By pivoting the actuating lever 3 about the actuating axis AB, the closure apparatus 48 can also be pivoted about the actuating axis AB. In this way, the closure apparatus 48 can for example be pivoted between a blocking position blocking an opening of the access control device 14 and an opening position enabling an opening of the access control device 14.

### LIST OF REFERENCE NUMERALS

1 Swivel lever system
2 Swivel lever
3 Actuating lever
4 Base part
5 Rotary plate
6 Lever receptacle
7 Locking section
8 Recess
9 Bottom
10 Key
11 Key magnet
12 Key receptacle
13 Key opening
14 Access control device
15 Locking element
16 Guide
17 Adjusting magnet
18 Guide
19 Holding element
20 Locking receptacle
21 Securing element
22 Spring means
23 Locking element
24 Adapter element
25 Longitudinal strut
26 Screw connection
27 Base body
28 Locking section
29 Magnet receptacle
30 Adjusting magnet
31 Securing magnet
32 Magnet receptacle
33 Securing magnet
34 Magnet receptacle
35 Cover cap
36 Screw connection
37 Protective flap
38 Undercut
39 Undercut
40 Master key magnet
41 Empty space
42 Form element
43 Key magnet
44, 45, 46, 47 Sliding surface
48 Closure apparatus
AA Latching axis
AB Actuating axis
AS Pivot axis
E Contact plane
FR Restoring force
LBH Longitudinal axis
LBT Longitudinal axis
LVE Longitudinal axis
RF Release direction

1. A swivel lever for actuating a closure apparatus, in particular a bolt closure means and/or rod closure means, of an access control device, in particular of a door and/or hatch, having:
a base part for fastening the swivel lever, in particular to the access control device, and
an actuating lever for actuating the closure apparatus,
wherein the actuating lever is pivotable relative to the base part between a latched position for latching the actuating lever on the base part and an actuating position for actuating the closure apparatus and/or when the closure apparatus is actuated and
wherein at least one locking element for securing the actuating lever-against unauthorised pivoting from the latched position into the actuating position is provided so as to be adjustable between a locking position positively blocking the pivoting of the actuating lever and a release position enabling the pivoting of the actuating lever,
wherein
the at least one locking element is adjustable from a base position into an unlocking position from the locking position into the release position by adjusting at least one adjusting magnet,
in that the at least one adjusting magnet is adjustable from the base position into the unlocking position by way of a magnetic interaction with at least one key magnet of a key suitable for the swivel lever and
in that the at least one locking element and the at least one adjusting magnet are formed from different materials.

2. The swivel lever according to claim 1,
wherein
at least two, if necessary at least three, preferably at least four, in particular at least six, particularly preferably at least eight, locking elements adjustable in each case between a locking position and a release position and adjusting magnets, in particular in each case assigned to one of the locking elements, are provided and/or
in that at least one lateral locking element is provided for positively blocking the pivoting of the actuating lever on a longitudinal side of the actuating lever and/or at least one rear locking element is provided for positively blocking the pivoting of the actuating lever on a rear side of the actuating lever assigned to the base part.

3. The swivel lever according to claim 1,
wherein
the at least one adjusting magnet is formed from a permanently magnetic material and/or the at least one locking element is formed from a non-permanently magnetic material and/or
in that the at least one locking element is formed from a ferromagnetic or a non-ferromagnetic material.

4. The swivel lever according to claim 1,
wherein
the material of the at least one locking element has a higher shear strength than the material of the adjusting magnet, in particular assigned to the locking element, and/or
in that the, in particular rear, locking element is manufactured by die-casting and/or
in that the at least one locking element is formed from a metallic material, preferably steel material, in particular ferritic steel material, aluminium material and/or zinc material.

5. The swivel lever according to claim 1,
wherein
the at least one, in particular lateral, locking element and the adjusting magnet, in particular assigned to the locking element, are adjustable independently of one another and/or
in that the, in particular rear, locking element and the adjusting magnet, in particular assigned to the locking element, are adjustable exclusively together and/or
in that the at least one locking element is adjustable positively from the locking position into the release position by the adjusting magnet, in particular assigned to the locking element.

6. The swivel lever according to claim 1,
wherein
the at least one, in particular lateral, locking element is displaceable between the locking position and the release position and/or the at least one adjusting magnet, in particular assigned to the lateral locking element, is displaceable between the base position and the unlocking position, in particular along the longitudinal axis of the locking element and/or at least substantially parallel to a contact plane of the swivel lever for contact with the access control device and/or
in that the, in particular rear, locking element is displaceable between the locking position and the release position and/or the adjusting magnet, in particular assigned to the rear locking element, is displaceable between the base position and the unlocking position about a pivot axis which is, in particular, at least substantially parallel to a contact plane of the swivel lever for contact with the access control device.

7. The swivel lever according to an claim 1,
wherein
the at least one locking element and/or the at least one adjusting magnet is held so as to be adjustable, in particular in a captive manner and/or in a guide, on the base part or actuating lever and
in that, preferably, the at least one, in particular lateral, locking element is held on the base part and the at least one adjusting magnet, in particular assigned to the locking element, is held on the actuating lever or vice versa and/or the, in particular rear, locking element and the at least one adjusting magnet, in particular assigned to the locking element, are held on the base part or on the actuating lever.

8. The swivel lever according to claim 1,
wherein
the, in particular rear, locking element is arranged at least partially, in particular at least substantially, on the side of a contact plane of the swivel lever facing away from the actuating lever for contact with the access control device and
in that, preferably, the actuating lever has at least one, in particular hook-shaped, locking section, engaging the contact plane in the latched position of the actuating lever to form the at least one positive-locking connection, which blocks the pivoting of the actuating lever, with the, in particular rear, locking element.

9. The swivel lever according to claim 1,
wherein
the, in particular rear, locking element, has an at least substantially L-shaped base body and, preferably, at least one locking section protruding laterally from the base body for forming the at least one positive-locking connection blocking the pivoting of the actuating lever and/or
in that the adjusting magnet in particular assigned to the rear locking element, is received at least partially, in particular at least substantially, in an, in particular correspondingly designed, magnet receptacle of the locking element.

10. The swivel lever according to claim 1,
the, in particular rear, locking element in the locking position positively engages behind at least one undercut-of the actuating lever in the latched position and/or vice versa and/or
in that in the latched position of the actuating lever, the at least one, in particular lateral, locking element engages positively in a locking receptacle of the actuating lever or of the base part in the locking position.

11. The swivel lever according to claim 1,
wherein
at least one securing element is provided for holding the at least one locking element in the locking position and, in particular, for automatically adjusting the at least one locking element from the release position into the locking position, preferably by way of an, in particular magnetic, securing force, and
in that, preferably, the at least one securing element is a securing magnet formed in particular by the at least one adjusting magnet or separate from the at least one adjusting magnet.

12. The swivel lever according to claim 1,
wherein
at least one holding element, in particular separate from the at least one securing element, is provided for holding the at least one adjusting magnet, in particular assigned to the lateral locking element, in the base position and, in particular, automatically adjusting the at least one adjusting magnet from the unlocking position into the base position, preferably by way of an, in particular magnetic, holding force and
in that, preferably, the at least one holding element is formed from a ferromagnetic and/or non-permanently magnetic material and/or is formed as a sheet metal.

13. The swivel lever according to claim 1,
wherein
the at least one locking element is adjustable automatically, in particular positively, from the locking position into the release position when the actuating lever is pivoted from the actuating position into the latched position and
in that, preferably, the actuating lever and/or the at least one locking element has at least one sliding surface, for automatically adjusting the at least one locking element from the locking position into the release position by sliding on the locking element or the actuating lever.

14. The swivel lever according to claim 1,
wherein
the actuating lever is pivotable against a restoring force, in particular of a spring means, into the latched position and
in that, preferably, in the latched position of the actuating lever, a force counteracting an adjustment into the release position acts on the at least one locking element in the locking position by way of the restoring force and
in that, further preferably, the force counteracting the adjustment into the release position is caused by a frictional connection, in particular between the locking element and the actuating lever and/or base part.

15. The swivel lever according to claim 1,
wherein
a key receptacle, which extends in particular along the longitudinal axis of the actuating lever and/or of the base part and/or is formed by the actuating lever and/or the base part, is provided for receiving the key, at least in sections and
in that, preferably, at least two of the adjusting magnets and/or two holding elements, in particular assigned to one of the lateral locking elements, are arranged on opposite sides, in particular longitudinal sides, of the key receptacle.

16. A swivel lever system having
at least one swivel lever according to claim 1 and
a key which is suitable for the swivel lever and comprises at least one key magnet for adjusting the at least one adjusting magnet of the swivel lever from the base position into the unlocking position.

17. The swivel lever system according to claim 16,
wherein
the key receptacle of the swivel lever and the key have cross-sections corresponding to one another, in particular with corresponding form elements for aligning the key in the key receptacle, and/or
in that the key is designed as a master key and has at least one master key magnet assigned to an empty space of the swivel lever for unlocking at least one further swivel lever.
